(19) United States
(12) Patent Application Publication
(10) Pub. No.: US 2024/0238807 A1
(43) Pub. Date: Jul. 18, 2024

(54) CENTRIFUGAL SCREEN FILTER AND RELATED METHOD OF ASSEMBLY

(71) Applicant: AQSEPTENCE GROUP, INC., New Brighton, MN (US)

(72) Inventors: Warren BERG, New Brighton, MN (US); Michael Fitzstephens, New Brighton, MN (US); Daryn Bertelson, New Brighton, MN (US)

(21) Appl. No.: 18/559,271

(22) PCT Filed: May 4, 2022
(86) PCT No.: PCT/US2022/027704

§ 371 Date: Nov. 6, 2023

Related U.S. Application Data
(60) Provisional application No. 63/184,177, filed on May 4, 2021.

(51) Int. Cl. B04B 7/18

(52) U.S. Cl. CPC B04B 7/18

(57) ABSTRACT

A centrifugal screen filter and methods of assembly to accommodate variability in batch centrifuges by utilizing two different style joint connections when assembling the individual screen panels to form the centrifugal screen filter. A first joint configuration can include a fixation member that fixes the first joint configuration relative to the batch centrifuge by engaging the batch centrifuge. A second joint configuration can utilize an elongated, compressible member to provide flexibility and scaling capability to additional joint connections between adjacent screen panels. The centrifugal screen filter can utilize only a single first joint configuration with the remaining connections being of the second joint configuration. Alternatively, the centrifugal screen filter can be constructed utilizing one or more pairs of first joint configurations, wherein the pair or pairs of first joint configurations are located in opposed positions of the centrifugal screen filter and the remaining connections are of the second joint configuration.

### PRIORITY CLAIM

The present application claims priority to United States provisional application serial number 63/184,177 filed May 4, 2021 and entitled “CENTRIFUGAL SCREEN FILTER AND RELATED METHODS OF ASSEMBLY”, which is hereby incorporated by reference in its entirety.

### FIELD OF THE INVENTION

The present invention is directed to centrifugal screen filters. More specifically, the present invention is directed to a batch centrifugal screen filter utilizing at least one first joint configuration utilizing a fixation member and a second joint configuration utilizing an elongated compressible member to allow for quick and easy assembly of adjacent screen panels within a batch centrifuge.

### BACKGROUND OF THE INVENTION

A conventional sugar refining process employs a centrifuge to separate sugar crystals out of raw molasses. In some instances, the centrifuge design can be either of a batch or continuous centrifuge design. Regardless of the way the centrifuge is operated, both batch and continuous centrifuges can make use of a screen filter. A representative example of a batch centrifugal screen filter is described in US Patent Publication 2018/0207650 while representative continuous centrifugal screen filters are described in U.S. Pat. Nos. 6,663,774, 6,761,821 and US Patent Publication No. 2014/0076796, all of the preceding being assigned to the present applicant, Aqseptence Group, Inc. of New Brighton, MN and all of which are hereby incorporated by reference in their entirety.

In some instances, batch centrifugal screen filters are manufactured such that individual screen panels can be individually installed and subsequently connected within the centrifuge. Generally, these screen panels are of rigid construction, which can make them difficult to manipulate and install within the batch centrifuge, especially when trying to align and connect a final joint during such installation and assembly.

In order to reduce time and simplify the installation process, it would be advantageous to incorporate a screen filter design that provides flexibility when assembling a final joint connection.

### SUMMARY OF THE INVENTION

The present invention addresses dimensional variability in centrifuges by allowing a centrifuge screen to be installed and assembled utilizing two different style joint connections when assembling the individual screen panels to form the centrifugal screen filter. Generally, a first joint connection comprises a fixation member that operably fixes the first joint configuration relative to a batch centrifuge by positively engaging the batch centrifuge. A second joint configuration utilizing an elongated, compressible member provides dimensional flexibility and sealing capability to additional joint connections between adjacent screen panels. In one representative embodiment, a centrifugal screen filter utilizes only a single first joint configuration with the remaining connections being of the second joint configuration. In another representative embodiment, a centrifugal screen filter can be constructing utilizing one or more pairs of first joint configurations, wherein the pair or pairs of first joint configurations are located in opposed positions of the centrifugal screen filter.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

The detailed description particularly refers to the accompanying figures in which:

FIG. 1 is a perspective, partially hidden view of a conventional batch centrifuge of the prior art used in sugar processing.

FIG. 2 is an end view of a batch centrifuge screen of the prior art for use with the batch centrifuge of FIG. 1.

FIG. 3 is a perspective view of one screen panel of the of the batch centrifuge screen of FIG. 2.

FIG. 4 is a perspective view of the batch centrifuge screen of FIG. 2.

FIG. 5 is a top, perspective view of a centrifugal screen filter according to a representative embodiment of the present invention.

FIG. 6 is a side view of the centrifugal screen filter of FIG. 5.

FIG. 7 is a section view of the centrifugal screen filter of FIG. 5 taken at line 7-7 of FIG. 6.

FIG. 8 is a side view of a curved screen panel for use in constructing the centrifugal screen filter of FIG. 5.

FIG. 9 is an end view of the curved screen panel of FIG. 8.

FIG. 10 is an enlarged end view of the curved screen panel of FIG. 8 taken at Detail 10 of FIG. 9.

FIG. 11 is an enlarged end view of the curved screen panel of FIG. 8 taken at Detail 11 of FIG. 9.

FIG. 12 is an enlarged section view of a first joint configuration taken at Detail 12 of FIG. 7.

FIG. 13 is an exterior, side view of the first joint configuration of FIG. 12.

FIG. 14 is a side view of a fixation pin used in the first joint configuration of FIG. 12 according to a representative embodiment of the present invention.

FIG. 15 is a perspective view of the fixation pin of FIG. 14.

FIG. 16 is a perspective view of the fixation pin of FIG. 14.

FIG. 17 is an enlarged section view of a second joint configuration taken at Detail 17 of FIG. 7.

FIG. 18 is a side view of an elongated gasket member used in the second joint configuration of FIG. 17 according to a representative embodiment of the present invention.

FIG. 19 is a section view of the elongated gasket member taken at line 19-19 of FIG. 18.

FIG. 20 is a section view of a screen panel connection taken at Detail 20 of FIG. 7 depicting both the first joint configuration of FIG. 12 and the second joint configuration of FIG. 17.

FIG. 21A is a front view of a curved screen panel according to another embodiment of the present invention.

FIG. 21B is a side view of the curved screen panel of FIG. 21A.

FIG. 21C is a side view of the curved screen panel of FIG. 21A.

FIG. 21D is an interior view of the curved screen panel of FIG. 21A.

FIG. 21E is an exterior view of the curved screen panel of FIG. 21A.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

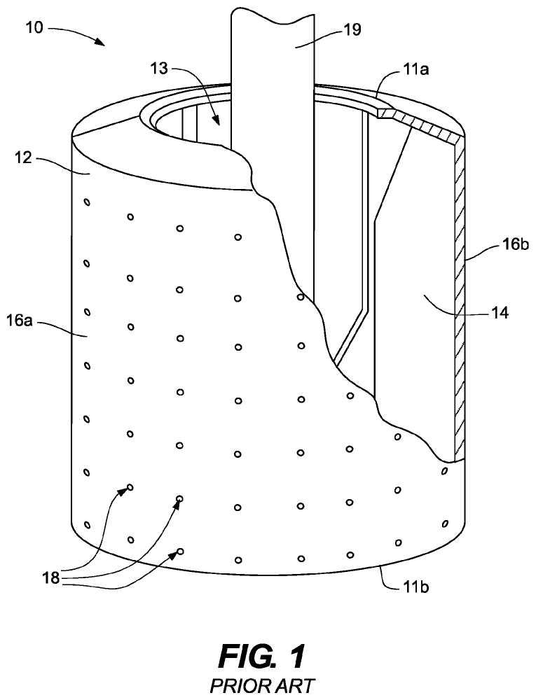

With reference to FIG. 1, an exemplary batch centrifuge 10 (hereinafter “the centrifuge 10”) of the prior art is shown. The centrifuge 10 comprises a first end 11a, an opposite second end 11b and a basket 12 arranged along a centrifuge axis. First end 11a can comprise at least one opening 13. In some embodiments the basket 12 is substantially cylindrical with a circular cross section, while in other embodiments the basket may comprise one or more of suitable elliptical, polygonal or curvilinear cross-sections. The basket 12 can further comprise a plurality of apertures or perforations 18 for allowing liquid to be drained out of the basket 12 during a sugar separation process in a manner that will be familiar to those of ordinary skill in the art. In some embodiments, a cylindrical filter screen 14 may be disposed within the basket 12 in a radially close clearance relationship with the interior surface 16b of the basket 12. The design and materials of the support components can be selected such that components can withstand high torque and axial and tangential stresses and strains, without affecting their structural integrity, while having minimal weight.

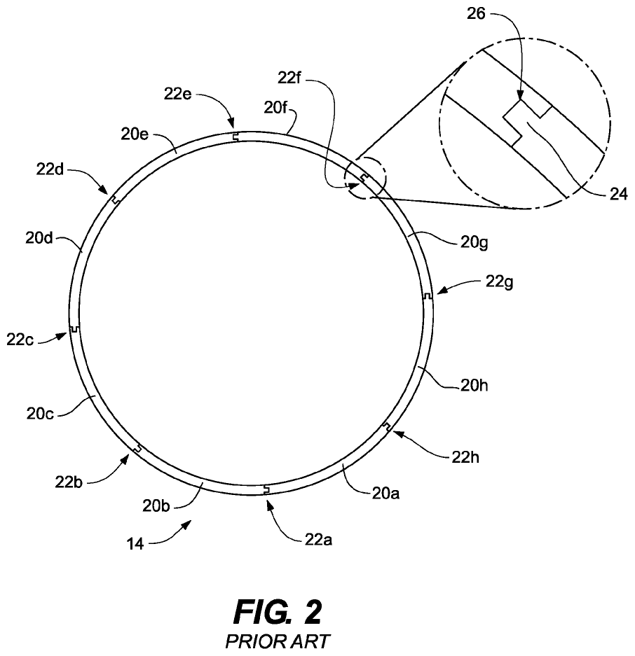

As best shown in FIG. 2, the cylindrical filter screen 14 can be formed of a plurality of curved screen panels 20a-h that are joined together at their lateral sides via a lateral joint 22a-h to form the assembled cylindrical filter screen 14. In some embodiments each of the panels 20a-h can cover at least a portion of the basket 12 and may be shaped substantially similar to the curvature of the basket 12. The optimal size and number of the curved screen panels 20 can be determined based on a number of factors such as the size of opening 13 and the dimensions of the basket 12. For example, a basket with the capacity of 30-40 pounds may require 8 panels while in other examples, it may be appropriate to utilize up to 16 panels. Although termed and illustrated as curved screen panels 20a-h forming a cylinder, for the purposes of example, and not limitation, other embodiments the screen panels 20a-h may be shaped like flat planes, Euclidean planes, sections of a cylinder, cone or any other three-dimensional geometry, Riemann surfaces or a combination of the above.

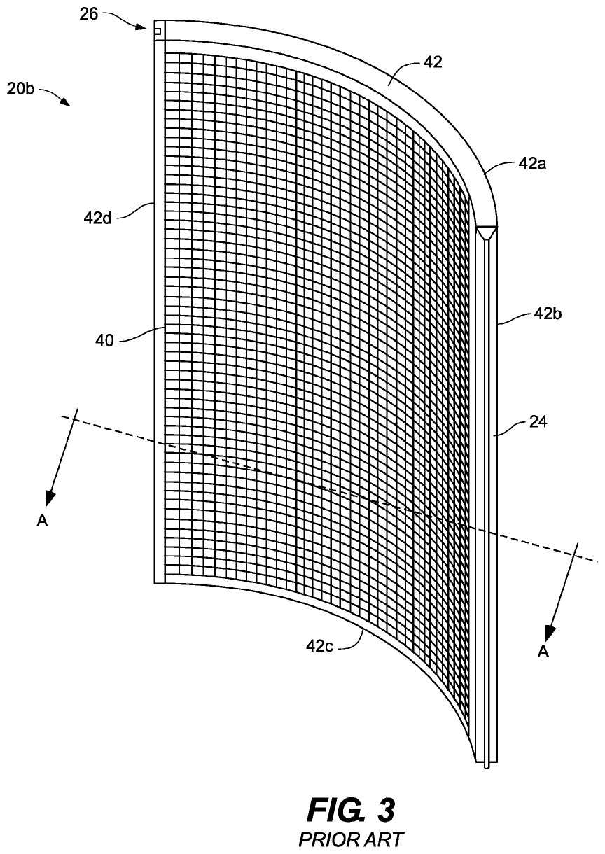

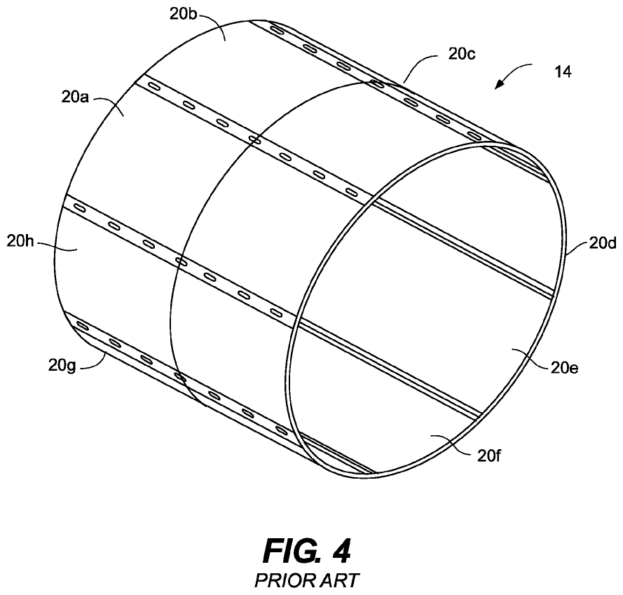

An exemplary curved screen panel 20b of prior art is illustrated in FIG. 3. It will therefore be understood that the following description of the curved screen panel 20b can generally apply to each of the plurality of curved screen panels 20a, and 20c-h. The curved screen panel 20b comprises a proximal side 42a, lateral sides (42b, 42d) and a distal side 42c. Although illustrated as comprising four sides, the curved screen panel 20b can comprise more or fewer sides and can be of any suitable shape. The curved panel further comprises a frame 42 forming at least a portion of the perimeter of a screen portion 40. In the exemplary embodiment, the frame 42 surrounds the screen portion 40 on all the sides and is of a substantially similar shape as that of the screen portion 40. The frame 42 of the curved screen panel 20b can be formed of solid metal bar elements that may be welded or otherwise rigidly affixed to the edges of the screen portion 40. The screen portion 40 further comprises an inner surface facing the interior of the basket 12 and an outer surface facing the interior surface of the basket 12 when assembled. For reasons that will become apparent below, in some embodiments the individual curved screen panel 20b can be sized to be small enough to fit through an opening 13 of the basket 12 without requiring deformation or flexure of the curved screen panel 20b while in other embodiments, the curved screen panel 20b may be slightly deformed, albeit temporarily, to insert through the opening 13.

Generally, the frame 42 and the screen portion 40 can be manufactured out of same or different materials, such as suitable grades of stainless steel (For example: SAE 300, 400, austenitic steels and the like), carbon steels, suitable metals, alloys, plastics, composites, natural or synthetic materials, polymers and the like. The materials can be chosen for the specific application based on their strength, ductility/malleability, weight, rigidity/flexibility, operative temperature ranges, magnetic properties and the like. Typically, the materials and the fastening methods are chosen such that the curved screen panel 20b is substantially rigid to withstand loads but flexible enough to be inserted through the opening 13. The material can also be chosen such that the curved screen panel 20b undergoes elastic deformation both during assembly and operation without fatigue or fracture. Furthermore, based on the application, the materials can be chosen for their corrosion resistance, chemical stability or their properties can be augmented by use of coatings or sprays possessing hydrophobic, hydrophilic, oleophobic or other suitable properties. In addition seals and gaskets made of rubber and other materials can be used between two or more components for effective sealing and/or to preclude galvanic corrosion.

The screen portion 40 is formed with a plurality of openings or apertures, with the size and arrangement of the apertures suitably designed based on the application of the screen. In some embodiments the screen portion 40 is constructed out of spirally wrapped wires that form slots and serve as a filtration material. In some embodiments, the screen portion 40 may include as filtration material, a plurality of spaced filter wires, or a wire mesh supported on support rods (not shown). The screen portion 40 is constructed out of one or more screens of filtration material. In some embodiments, the screens may include shaped wire, for example, wedge or “Vee-Wire” type screens. In some embodiments, the screen portion 40 may include as filtration material, plates (not shown) having perforations, slots, or other filter-type openings. In some embodiments, the spacing and sizes of wires, or other openings, vary along the length or the circumference of the screen portion 40. In some embodiments, the screen portion 40 may include as filtration material any combination of wires and plates. In some embodiments the filtration material is magnetic to filter metallic wastes.

In the “Vee-Wire” type of screen, a filtering surface is formed by wires with a V-shaped cross-section, meaning that they each have a generally triangular-shaped cross-section and which typically are parallel at constant intervals, the space between wires forming the slots of the screen. The wires can be constructed out of circular, polygonal, or any other suitable cross-section based on requirements. In some embodiments these wires are welded to filter support rods (not shown) oriented essentially perpendicularly with respect to the wires, and may be relatively thin in order to maximize the effective opening of the slots. Such a screen portion 40 may have the advantage of being very strong and being resistant to clogging. The screen portion 40 allows fluids and specifically liquids, to pass through it, while preventing particulate matter (For example: sugar crystals) greater than a predetermined size from exiting the interior volume of the basket 12. In some embodiments, each wire includes an inner surface and two lateral surfaces which may converge to a point or another surface based on the cross-section of the wires. The wires are aligned, side-by-side, with their inner surfaces perpendicular to the basket axis to form a set of wires. When using wires of V-shaped cross-section, a channel is created between lateral surfaces of consecutive wires. Because of the triangular shaped cross-section of the wires in some embodiments, the channels between consecutive wires open away from the plane defined by the face surfaces of the filter wires. Put another way, the filter channels might not have parallel walls, but instead may flare from the face surfaces to the points of the wires.

Multiple sets of wires can be arranged at an angle with each other in the same plane and joined to form the screen portion 40. Therefore, the one or more sets of wires create the screen portion 40 and define the interior volume of the assembled filter screen 14. Furthermore, the sets of wires and the filter support rods, if any are present, can be constructed out of metals, composites, plastics, coated materials, natural or synthetic materials based on the desired properties and ease of manufacture, as described previously. In some embodiments of the invention the screen may be created along a flat surface or other shaped surface, and then cut, bent or plastically deformed, to create the required contour for screen portion 40. While in other embodiments, the sets of wires may be cast or extruded in the desired contour and then fastened or welded together. Therefore, the screen portion 40 may be formed of one or more layers of wire mesh, perforated sheet metal, or any other structure, configuration, and/or material that is suitable to act as a filter for separating sugar crystals from massecuite during operation of the centrifuge 10. In this regard the mesh size of the wire mesh, or size of the perforations, openings or apertures in the screen portion may be chosen based on the size of the sugar crystals to be filtered. For instance a fine mesh may be used to filter small crystals and a relatively coarse mesh may be used to filter larger sugar crystals. The screen portion 40 may be thicker, more rigid, and more durable than traditional, collapsible filter screens of the type found in many conventional batch centrifuges. For example, the screen portion 40 may be sufficiently thick and/or rigid so as to resist significant bending or deformation under the application of manual force by a human being of average strength. In one non-limiting example, the screen portion 40 may have a thickness in a range of about ¼ inch to about ½ inch. The screen portion 40 may be thicker/thinner than the frame portion 42.

As illustrated in FIG. 3, the plurality of curved screen panels 20a-h can be fabricated such that the lateral sides 42b, 42d provide a lateral connection joint 22a-h between adjacent curved screen panels. For example, the frame 42 of the curved screen panel 20b can comprise a tongue feature 24 defined on the lateral side 42b and a groove feature 26 defined on the lateral side 42d. The tongue feature 24 can comprise a projection/protrusion that extends at least along a portion of the length of the lateral side 42b. The tongue feature 24 can comprise square, quadrilateral, triangular, polygonal or curvilinear cross-sections or a combination of suitable cross sections throughout its length. The cross-section of the tongue feature 24 can comprise one or more sides. The one or more sides of the tongue feature 24 can be oriented at a suitable angle with respect to the frame portion 42. For example the sides can be perpendicular to the lateral side 42b as illustrated in FIG. 3 or can be oriented at acute/obtuse angles to form a dovetail joint. Furthermore, the tongue feature 24 can be placed towards the inner surface or the outer surface of the curved screen panel 20b or can be centered in between. In some embodiments the tongue feature 24 extends throughout the length of the lateral side 42b in a straight line or a suitable curve, while in other embodiments the tongue feature 24 extends only along a portion or at intermittent intervals along the length of the lateral side 42b. The groove feature 26 can comprise a recess/depression extending along at least a portion of the length of the lateral side 42d to receive the tongue feature 24 of an adjacent curved panel and/or the curved screen panel 20b. In some embodiments the cross section and length of the groove feature 26 is complementary to the tongue feature 24 of an adjacent curved panel. In some embodiments, the cross-sections of the tongue and groove features (24, 26) are chosen such that the tongue feature 24 can be inserted into the groove feature 26 of an adjacent curved panel in a direction perpendicular to the lateral side 42d or in a direction oriented at a finite angle with the lateral side 42d. In this regard the curved panels can be assembled on-site and within the basket 12 by a snap joint, interference, clearance or transition fit based on the application. In other embodiments, the cross-sections of the tongue and groove features (24, 26) are chosen such that the tongue feature 24 can be slid into the groove feature 26 of an adjacent curved panel in a direction parallel to the lateral side 42d. In some embodiments additional components can be placed in between the tongue and groove features (24, 26) during assembly for enhanced sealing.

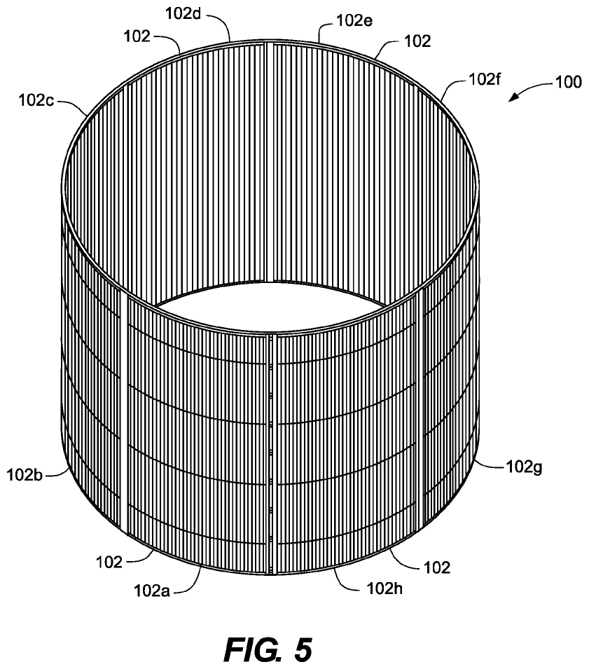

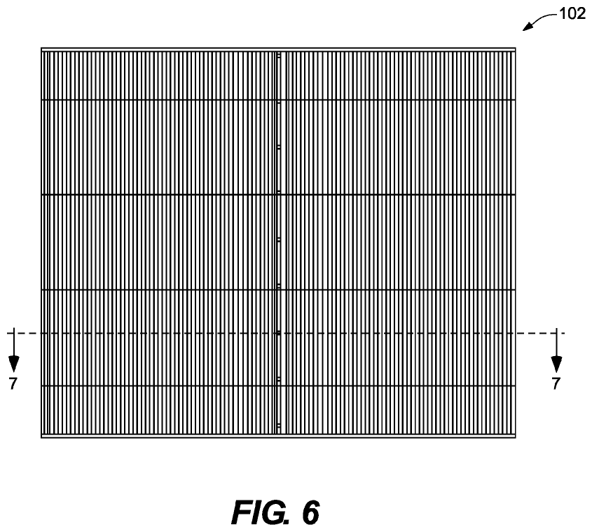

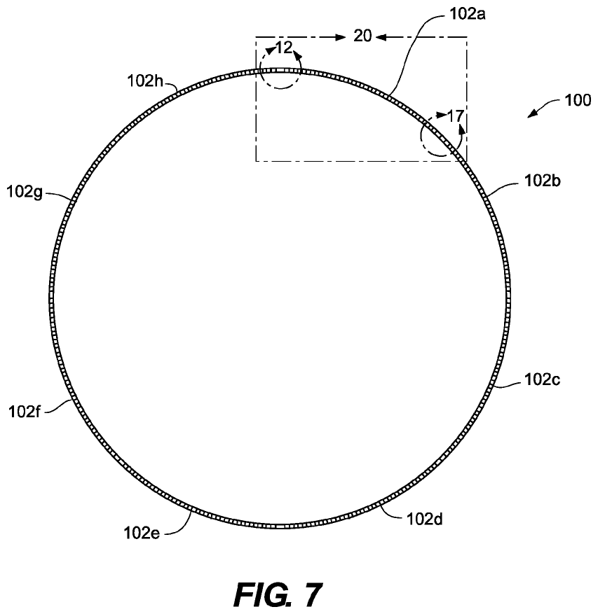

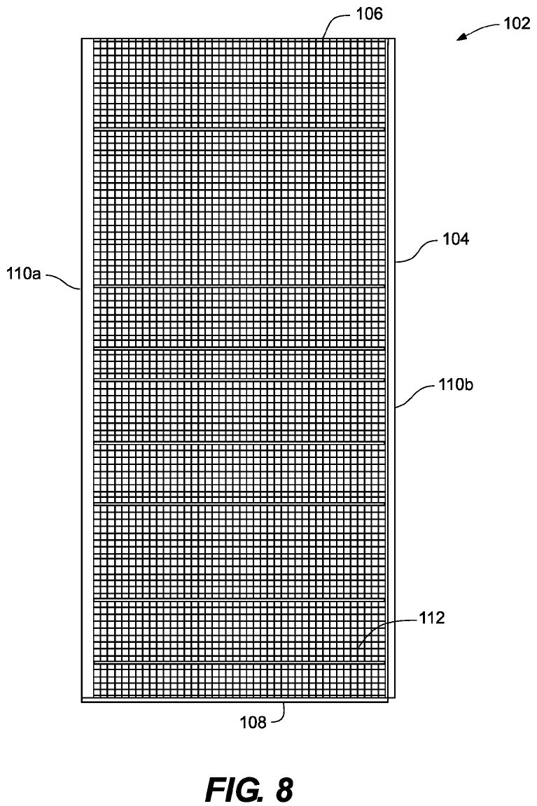

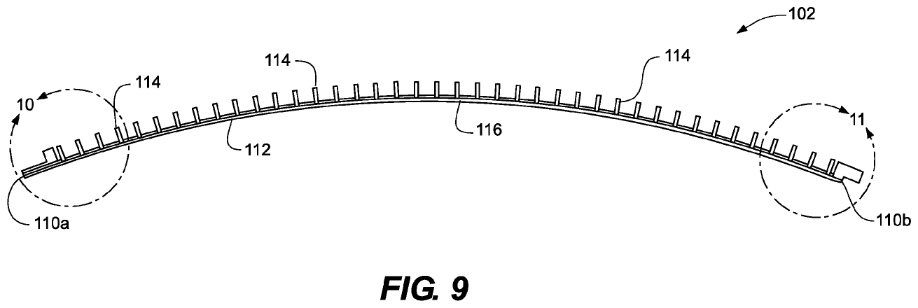

A centrifugal screen filter 100 of the present invention is illustrated generally in FIGS. 5, 6 and 7. Generally, the centrifugal screen filter 100 can be formed of a plurality of curved screen panels 102 as shown in FIGS. 8 and 9, for example, eight curved screen panels 102a, 102b, 102c, 102d, 102e, 102f, 102g and 102h. Alternatively, any number of curved screen panels 102 can be utilized to form centrifugal screen filter 100 depending upon the size and shape of batch centrifuge 10. Each curved screen panel 102 generally comprises a panel frame 104 defined by an upper side 106, a lower side 108 and a pair of lateral sides 110a, 110b. Generally, a screen surface 112 is formed by arranging a plurality of parallel support rods 114 between the upper side 106 and lower side 108, wherein a plurality of parallel, spaced apart shaped wire elements 116 can be coupled to the support bars 114. In some embodiments, the screen panels 102 can be originally formed in a flat, rectangular arrangement, wherein they are then formed into the curved screen panel 102 arrangement.

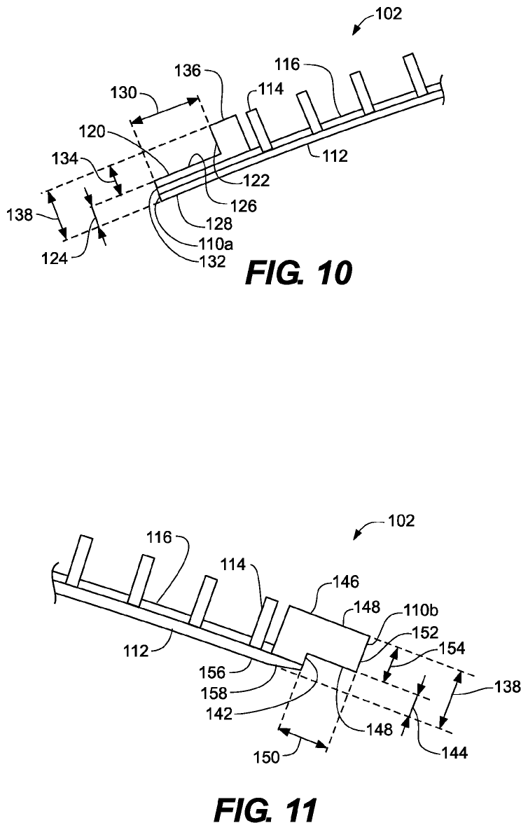

Lateral sides 110a, 110b are generally utilized to assemble the centrifugal screen filter assembly 100 by providing for adjacent curved screen panels 102 to be operably connected within the batch centrifuge 10. As seen in FIG. 10, lateral side 110a can define an interior edge member 120 extending from an interior flanged surface 122. Generally, the interior edge member 120 can have an interior edge width 124 defined between a first inner surface 126 and a first outer surface 128. The first inner surface 126 can have a first inner surface length 130 defined by a first end surface 132 and the exterior flanged surface 122. Exterior flanged surface 122 can have an exterior flange length 134 defined between the first inner surface 126 and a screen exterior surface 136. Generally speaking, the sum of the interior edge width 124 and the exterior flange length 134 will equal a panel width 138.

Lateral side 110b can define an exterior edge member 140 extending from an interior flanged surface 142 as shown in FIG. 11. Generally, the exterior edge member 140 can have an exterior edge width 144 defined between a second outer surface 146 and a second inner surface 148. The second inner surface 148 can have a second inner surface length 150 defined by a second end surface 152 and the interior flanged surface 142. Interior flanged surface 142 can have an interior flange length 154 defined between the second inner surface 148 and a screen interior surface 156. Generally speaking, the sum of the exterior edge width 144 and the interior flange length 154 will also equal the panel width 138 with the exterior edge width 144 being equal to the exterior flange length 134 and the interior flange length 154 being equal to the interior edge width 124. In some embodiments, a portion of the screen interior surface 156 proximate the interior flanged surface 142 can define a tapered edge 158.

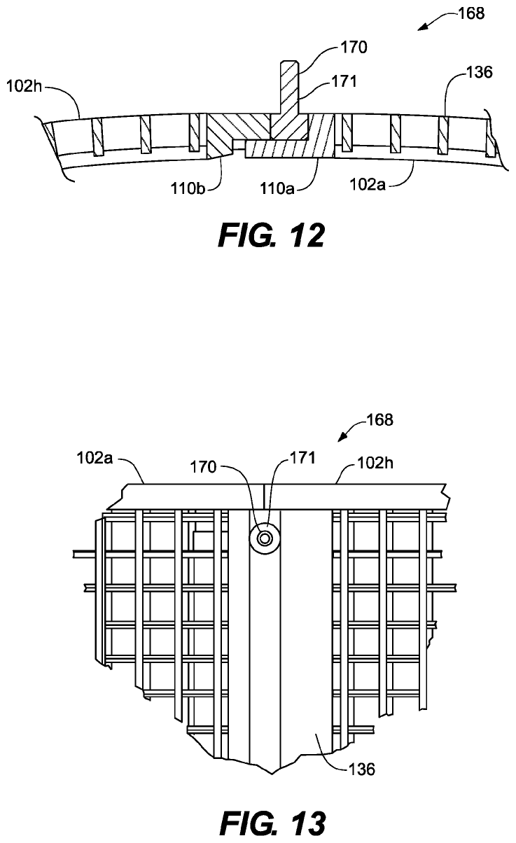

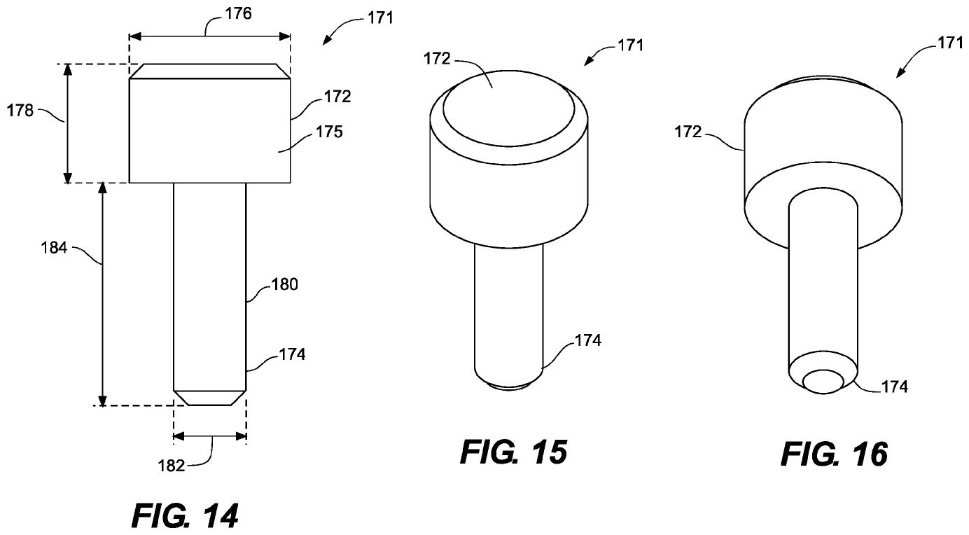

In addition to aligning lateral sides 110a, 110b of adjacent curved screen panels 102, joint assemblies used in assembling centrifugal screen filter assembly 100 within batch centrifuge 10 can comprise one of two possible configurations. As shown in FIGS. 12 and 13, a first joint configuration 168 can comprise the inclusion of a plurality of fixation members 170. In one preferred embodiment, fixation member 170 can comprise a fixation pin 171 as seen in FIGS. 14, 15 and 16. Alternatively, fixation member 170 can comprise a conventional nut and bolt arrangement (not shown) for making a positive coupling to the batch centrifuge 10 (not shown). Generally speaking, fixation pin 171 comprises a biasing end 172 and an insertion end 174. Generally speaking, biasing end 172 can comprise a biasing cylindrical portion 175 defining a biasing cylinder diameter 176 and having a biasing cylinder length 178, wherein said biasing cylinder length 178 is generally equal to the exterior edge width 144 and the exterior flange length 134. Biasing cylinder diameter 176 is less than the first inner surface length 130. Insertion end 174 defines an insertion cylindrical portion 180 having an end diameter 182 and an end length 184. Generally speaking, the end diameter 182 and end length 184 can be sized such that as the first joint configuration 168 is assembled, the insertion end 174 of each fixation pin 171 can be inserted through a wall opening defined in the batch centrifuge 10 such that the position of the first joint configuration 168 is fixed relative to the batch centrifuge 10.

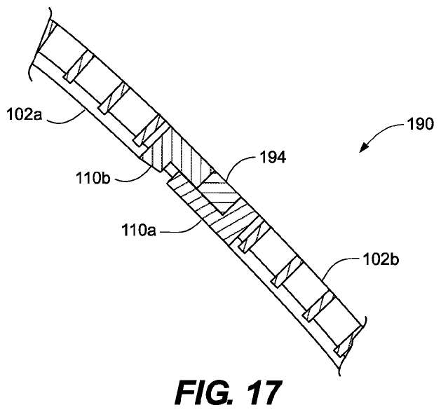

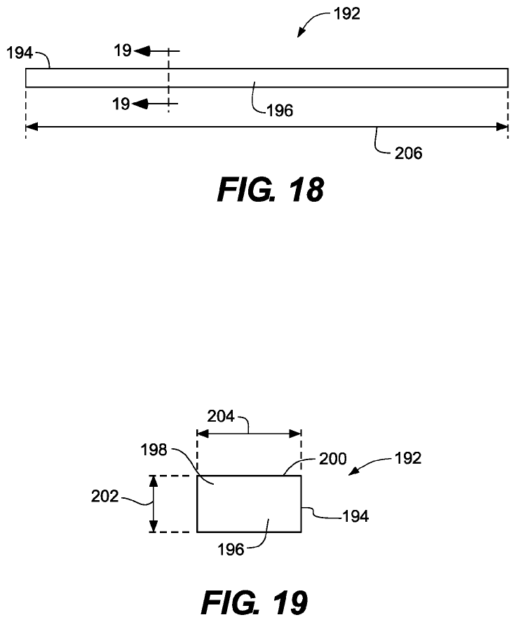

As shown in FIG. 17, a second joint configuration 190 can comprise the inclusion of a compressible member 192. In one preferred embodiment, compressible member 192 can comprise an elongated gasket member 194 formed of a compressible material 196 as shown in FIGS. 18 and 19. Preferably, compressible material 196 can comprise a food grade material such as, for example, Buna-n rubber, silicone rubber, EPDM rubber and neoprene rubber. Compressible member 192 can alternatively comprise an elongated metallic member having a cross-section allowing for spring-like compression such as, for example, a U-shaped or C-shaped cross-section. Generally, elongated gasket member 194 defines a gasket cross-section 198, for example, the rectangular cross-section 200 shown in FIG. 19. Alternatively, gasket cross-section 198 can be circular, oval or other suitable geometric shapes. Rectangular cross-section 200 generally defines a gasket thickness 202 that is generally equal to the exterior edge width 144 and the exterior flange length 134 Rectangular cross-section 200 further defines a gasket width 204 that is equal to or less than the second inner surface length 150. Elongated gasket member 194 generally has a gasket length 206 that is generally equal to the length of lateral sides 110a, 110b.

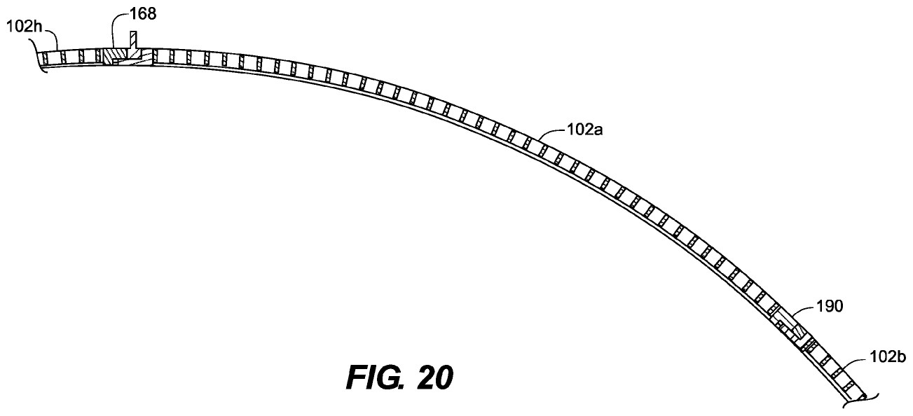

To assemble screen filter assembly 100, a user generally proceeds by serially installing and connecting screen panels 102, for example, as shown with curved screen panels 102h, 102a and 102b as shown in FIG. 20. The user first installs the fixation pins 171 in a spaced apart, vertical row such that the insertion end 174 of each fixation pin 171 is inserted through a wall opening 18 defined in the batch centrifuge 10. Next, the user positions the curved screen panel 102h within the batch centrifuge 10 such that the lateral edge 110b, and more specifically, the second end surface 152 resides against and abuts the biasing end 172 of each fixation pin 171.

With curved screen panel 102h in position against the fixation pins 171, the user proceeds counter-clockwise and positions curved screen panel 102g within the batch centrifuge 10. Generally, the user makes the first connection between the lateral edge 110a of curved screen panel 102h and the lateral edge 110b of curved screen panel 102g. This first connection generally comprises the second joint configuration 190 as shown in FIG. 17. The elongated gasket member 194 is positioned along the lateral edge 110a of curved screen panel 102h such that the gasket cross-section 198 resides against the first inner surface 126 and the exterior flanged surface 122. The user then slides the lateral edge 110b of curved screen panel 102g toward the lateral edge 110a of curved screen panel 102h such that the exterior edge member 140 enters a gap defined between the batch centrifuge 10 and the interior edge member 120. The user continues sliding the lateral edge 110b until the exterior edge member 140 contacts the elongated gasket member 194 and further sliding is prevented. As the gasket width 204 is less than the first inner surface length 130, a portion of second inner surface 148 will reside flush against the first outer surface 126 when the second joint configuration 190 is complete. With the second joint configuration 190 completed, the curved screen panels 102g and 102h are operably connected. The user continues counterclockwise and the process of forming second joint configuration 190 is repeated at the connection point between each lateral edge 110a and lateral edge 110b.

Once the user has installed all of the panels and the only remaining connection is between curved screen panel 102h and curved screen panel 102a, the user must snap the lateral edge 110a of curved screen panel 102a over the row of fixation pins 171. More specifically, the exterior flanged surface 122 and the first inner surface 126 must be snapped over and engage the biasing end 172 of each fixation pin 171 to complete the first joint configuration 168. As the curved screen panel 102a is snapped into position, the elongated gasket member 194 in each second joint configuration 190 is compressed. In the event that dimensional variability prevents the curved screen panel 102a from being snapped into position, the user can replace one or more of the elongated gasket members 194 with another elongated gasket member 194 having a smaller gasket width 204. Conversely, if screen panel 102a snaps into position without resistance or if the assembled screen filter assembly 100 feels or appears loose within the batch centrifuge 10, the user can replace one or more of the elongated gasket members 194 with another elongated gasket member 194 having a larger gasket width 204. Due to the interaction of the fixation pins 171 and the batch centrifuge 10, the position of the first joint configuration 168 and consequently the assembled screen filter assembly 100 is fixed relative to the batch centrifuge 10.

While the installation method has been described using only a single first joint configuration 168, it will be understood that it can be advantageous to use a second first joint configuration 168 at a joint location on an opposite side of the screen filter assembly 100. For example, a second first joint configuration 168 could be used to connect curved screen panels 102d and 102e opposite the first joint configuration 168 connecting curved screen panels 102a and 102h. When utilizing two of the first joint configurations 168, the user decides which of these two connections will be the final connection in assembling screen filter assembly 100. For example, if the user decides that the first joint configuration 168 between curved screen panels 102a, 102h will be the final connection, the user begins assembly by connecting curved screen panels 102d, 102e as the first connection. Once curved screen panels 102d and 102e are connected, the user then works in both directions toward the curved screen panels 102a, 102h until only the final first joint configuration 168 between 102a and 102h requires completion to complete assembly of the screen filter assembly 100.

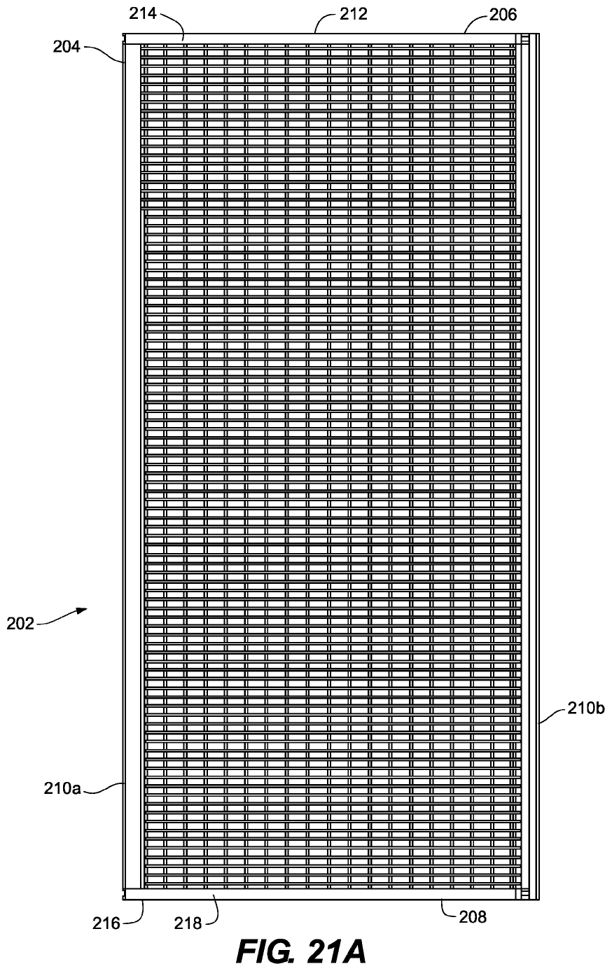

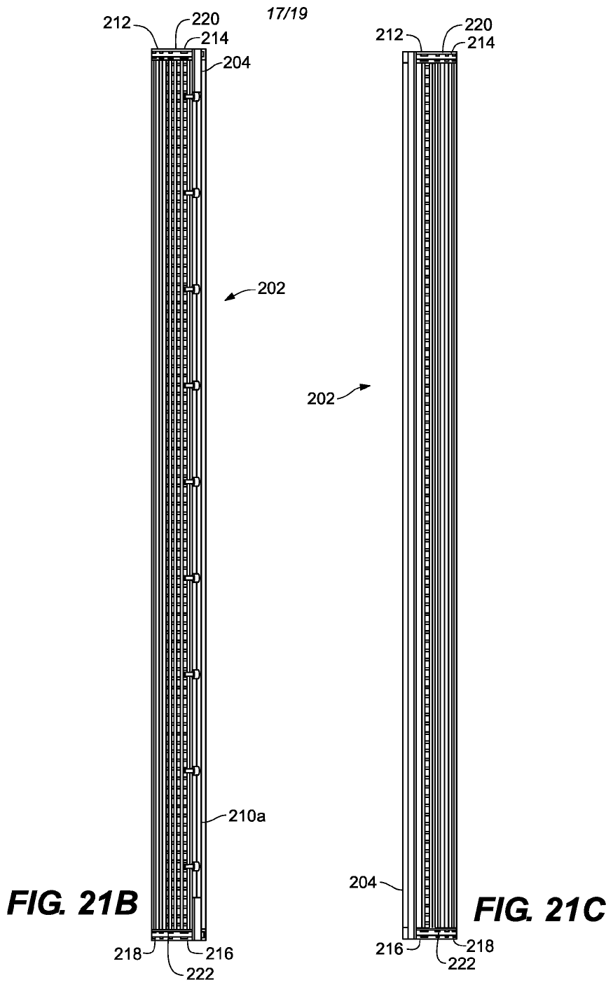

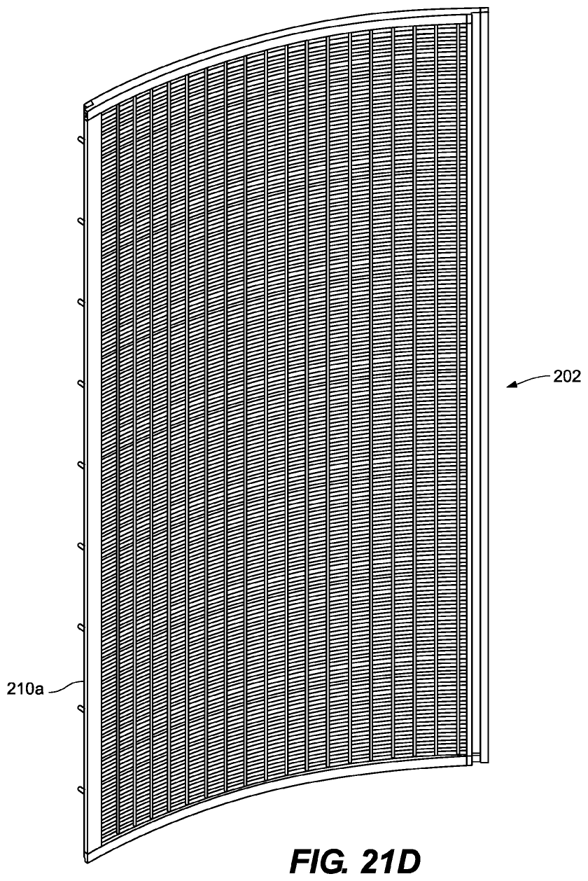

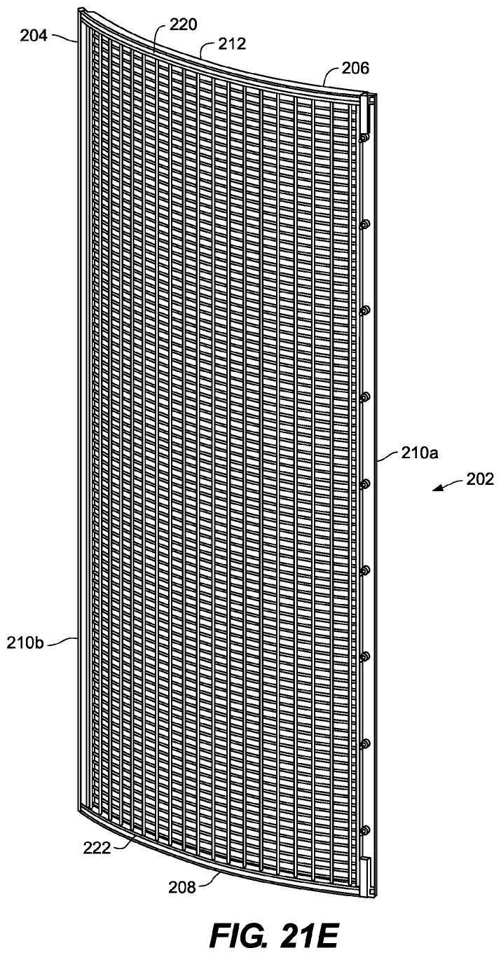

Referring now to FIGS. 21A, 21B, 21C, 21D and 21E, another embodiment of a curved screen panel 202 is illustrated that can be used to assemble the centrifugal screen filter 100 in a manner similar to that previously described with respect to curved screen panel 102. Generally, the curved screen panel 202 includes a panel frame 204 defining an upper side 206, a lower side 208 and a pair of lateral sides 210a, 210b. Upper side 206 is generally defined by an upper surface 212 and an upper side surface 214. Lower side 208 is generally defined by a lower surface 216 and a lower side surface 218. Mounted along the upper side surface 214 is an upper sealing gasket 220 while a lower sealing gasket 222 is mounted along the lower side surface 218. Upper sealing gasket 220 and lower sealing gasket 222 can comprise compressible materials intended to provide a seal between the centrifugal screen filter 100 and the interior surface 16b and prevent bypass of sugar. Upper sealing gasket 220 and lower sealing gasket 222 can comprise food grade materials such as, for example, Buna-n rubber, silicone rubber, EPDM rubber and neoprene rubber. In some embodiments, upper sealing gasket 220 and lower sealing gasket 222 can be alternatively mounted on upper surface 212 and lower surface 216 or in some embodiments, multiple upper sealing gaskets 220 and lower sealing gaskets 222 can be utilized, for example, one upper sealing gasket 220 on both of the upper surface 212 and upper side surface 214 and one lower sealing gasket 222 on both the lower surface 216 and lower side surface 218.

Although the invention has been described in detail with reference to certain preferred embodiments, variations and modifications exist within the scope and spirit of the invention as described and defined in the following claims.

1. A centrifuge screen filter, comprising:
a plurality of screen panels arranged to define a cylinder, each screen panel having an upper side, a lower side, a first lateral side and a second lateral side, wherein the first lateral side and the second lateral side of adjacent screen panels are engaged so as to define a plurality of connections around the cylinder, wherein at least one of the connections defines a first joint configuration, the first joint configuration utilizing a plurality of fixation members to fix the position of the first joint configuration relative to a batch centrifuge.

2. The centrifuge screen filter of claim 1, wherein each fixation member comprises a fixation pin having a biasing end and an insertion end and wherein the insertion end is insertable through a wall opening in the batch centrifuge.

3. The centrifuge screen filter of claim 2, wherein at least one of the connections defines a second joint configuration.

4. The centrifuge screen filter of claim 3, wherein each second joint configuration includes a compressible member.

5. The centrifuge screen filter of claim 4, wherein the compressible member comprises an elongated gasket member having a gasket width and a gasket length.

6. The centrifuge screen filter of claim 5, wherein the first lateral side and the second lateral side have an equal side length and wherein the gasket length is equal to the side length.

7. The centrifuge screen filter of claim 5, wherein the gasket width is selectable to facilitate assembly of the cylinder.

8. The centrifuge screen filter of claim 4, wherein the first lateral side defines an interior edge member and an interior flanged surface and wherein the second lateral side defines an exterior edge member and an exterior flanged surface.

9. The centrifuge screen filter of claim 8, wherein the compressible member of the second joint configuration is compressed between the interior flanged surface and the exterior edge member.

10. The centrifuge screen filter of claim 9, wherein the plurality of fixation members of the second joint configuration are captured between the interior flanged surface and the exterior edge member.

11. The centrifuge screen filter of claim 1, further comprising:
an upper gasket for sealing the upper side against the batch centrifuge; and
a lower gasket for sealing the lower side against the batch centrifuge.

12. The centrifuge screen filter of claim 11, wherein the upper gasket resides on an upper side surface and the lower gasket resides on a lower side surface.

13. The centrifuge screen filter of claim 1, further comprising a pair of the first joint configuration and wherein the pair of the first joint configuration reside on opposed sides of the cylinder.

14. A centrifuge screen filter, comprising:
a plurality of curved screen panels including at least a first curved screen panel, a second curved screen panel and a third curved screen panel, wherein each of the plurality of curved screen panels includes a first lateral edge and a second lateral edge,
wherein a second lateral edge on the first curved screen panel connects to a first lateral edge on the second curved screen panel with a first joint configuration, the first joint configuration including a fixation member for fixing a position of the first joint configuration relative to a batch centrifuge,
wherein a second lateral edge on the second curved screen panel connects to a first lateral edge on the third curved screen panel with a second joint configuration, the second joint configuration including a compressible member being compressed between the second curved screen panel and the third curved screen panel, and
wherein a second lateral edge on the third curved screen panel connects to a first lateral edge on the first curved screen panel with the second joint configuration, the compressible member being compressed between the third curved screen panel and the first curved screen panel.

15. The centrifuge screen filter of claim 14, wherein each of the plurality of curved screen panels includes an upper side and a lower side, wherein an upper gasket is mounted proximate the upper side and a lower gasket is mounted proximate the lower side, the upper gasket and the lower gasket sealing the curved screen panels against the batch centrifuge.

16. The centrifuge screen filter of claim 15, wherein the upper gasket resides on an upper side surface of the upper side and the lower gasket resides on a lower side surface of the lower side.

17. A method for assembling a centrifuge screen filter comprising:
positioning a plurality of fixation members in a vertical row on an inner wall of a batch centrifuge;
positioning a first screen panel proximate the vertical row of fixation members such that a second lateral side of the first screen panel abuts the vertical row of fixation members;
positioning a second screen panel proximate the first screen panel such that a first lateral side of the first screen panel engages a second lateral side of the second screen panel to define a first joint configuration;
positioning a third screen panel proximate the second screen panel such that a first lateral side of the second screen panel engages a second lateral side of the third screen panel to define the first joint configuration; and
engaging the first lateral side of the third screen panel with the second later side of the first screen panel to define a second joint configuration.

18. The method of claim 17, wherein the first joint configuration includes a compressible member.

19. The method of claim 18, further comprising:
capturing the compressible member between the first lateral side and the second lateral side when forming the first joint configuration.

20. The method of claim 19, further comprising:
adjusting a width of the compressible member in the first joint configuration to adjust the fit of the centrifuge screen filter within a batch centrifuge.

21. The method of claim 17, wherein each of the first, second and third screen panels includes an upper side and a lower side and wherein the method further comprises:
sealing the upper side of the first, second and third screen panels against a batch centrifuge with an upper gasket; and
sealing the lower side of the first, second and third screen panels against the batch centrifuge with a lower gasket.

22. The method of claim 17, further comprising:
positioning a second vertical row of fixation members in the inner wall wherein said second row of fixation members is on an opposed side of the batch centrifuge from the vertical row such that a pair of the second joint configuration can be defined on opposed sides of the batch centrifuge.
